(19) United States
(12) Patent Application Publication
(10) Pub. No.: US 2020/0227038 A1
(43) Pub. Date: Jul. 16, 2020

(54) APPARATUS, METHOD AND SYSTEM FOR CONDUCTING SURVEYS

(71) Applicant: AUS, Inc., Mount Laurel, NJ (US)

(72) Inventors: Michael A. BENDER, Burlington, NJ (US); Doris MEGEE, Edgewater Park, NJ (US); John L. RINGWOOD, Moorestown, NJ (US)

(21) Appl. No.: 16/249,466

(22) Filed: Jan. 16, 2019

(51) Int. Cl. G10L 15/22; G10L 15/18; G10L 15/30; G06Q 30/02

(52) U.S. Cl. CPC G10L 15/22; G10L 15/1815; G10L 2015/223; G06Q 30/0203; G10L 15/30

(57) ABSTRACT

Apparatuses and methods for conducting a survey are disclosed. In one embodiment, a computer is provided comprising processing circuitry configured to select a first audio data representing a first one of a plurality of survey questions to be output via a speaker; communicate the selected first audio data for output to the user via the speaker; receive a second audio data as a result of the first one of the plurality of survey questions being output via the speaker; determine whether the second audio data corresponds to one of a responsive answer and a non-responsive answer to the first one of the plurality of survey questions; and perform one of a responsive process and a non-responsive process based at least in part on the determination of whether the second audio data corresponds to the one of the responsive answer and the non-responsive answer.

### TECHNICAL FIELD

The present invention relates to data collection, and more particularly to an apparatus, method and system for conducting surveys and polls.

### BACKGROUND

Conventional surveys are conducted in many ways and using many different types of technology. For example, surveys are conducted by telephone; online/web-based using computers, notebooks and mobile phone equipment; on paper distributed via mail; and/or in-person (e.g., mall intercept). Such existing survey-conducting techniques are lacking. For example, telephone surveys typically involve physical call centers staffed with interviewers, which can be very costly and require a large amount of management overhead. Conventional online surveys generally require survey respondents to physically log onto computers or mobile devices, which can be inconvenient for users and are likewise easy to ignore. Furthermore, web-based online surveys may be considered impersonal and thereby less appealing to respondents. These and other drawbacks in existing survey-conducting techniques can reduce survey response rates and thereby increase the time and costs associated with completing survey projects.

### SUMMARY

Some embodiments of the present disclosure advantageously provide methods, apparatuses and systems for soliciting and conducting surveys, and gathering and organizing information and opinions from survey respondents, without conducting telephone surveys, paper surveys, or display-based online surveys. Thus, some embodiments of this disclosure may provide an improvement, over existing techniques, in the ability to conduct surveys without the costs of interviewer staff housed in a physical call center and/or without the need for survey respondents to physically log on to computers to conduct the survey. Further, some embodiments of this disclosure may provide techniques for improving survey respondent experiences by allowing survey respondents to take surveys on-the-fly via a smart speaker platform and to start, stop and resume surveys at their own convenience.

According to a first aspect of the present disclosure, a computer for conducting a survey is provided. The computer includes processing circuitry configured to select a first audio data representing a first one of a plurality of survey questions to be output via a speaker, the speaker being associated with a user and a speech interface assistant; communicate the selected first audio data for output to the user via the speaker; receive a second audio data as a result of the first one of the plurality of survey questions being output via the speaker; determine whether the second audio data corresponds to one of a responsive answer and a non-responsive answer to the first one of the plurality of survey questions; and perform one of a responsive process and a non-responsive process based at least in part on the determination of whether the second audio data corresponds to the one of the responsive answer and the non-responsive answer.

In some embodiments of this aspect, the responsive answer is a recognized answer and the non-responsive answer is an answer that is not recognized. In some embodiments of this aspect, the responsive process includes at least one of storing the second audio data in a survey database; and updating a persistent counter, the persistent counter being used to monitor which one of the plurality of survey questions was most recently communicated for output via the speaker. In some embodiments of this aspect, the non-responsive process includes at least one of: repeating the first one of the plurality of survey questions; rephrasing the first one of the plurality of survey questions; and not updating the persistent counter. In some embodiments of this aspect, the processing circuitry is further configured to monitor which one of the plurality of survey questions was most recently communicated for output via the speaker, the determination of whether the second audio data corresponds to the one of the responsive answer and the non-responsive answer based at least in part on the monitored one of the plurality of survey questions most recently output via the speaker. In some embodiments of this aspect, the processing circuitry is further configured to determine whether the second audio data corresponds to the one of the responsive answer and the non-responsive answer by being configured to determine whether the second audio data matches at least one predetermined answer corresponding to at least one intent. In some embodiments of this aspect, the processing circuitry is further configured to, as a result of the second audio data matching the at least one predetermined answer corresponding to the at least one intent, update a persistent counter and select a third audio data representing a second one of the plurality of survey questions to be output via the speaker associated with the speech interface assistant; and as a result of the second audio data not matching the at least one predetermined answer corresponding to the at least one intent, repeat the one of the plurality of survey questions most recently output.

In some embodiments of this aspect, the processing circuitry is further configured to determine whether the second audio data corresponds to the one of the responsive answer and the non-responsive answer by being configured to communicate the second audio data to the speech interface assistant for verification by comparing the second audio data to a predetermined list, the predetermined list associated with the first one of the plurality of survey questions output via the speaker. In some embodiments of this aspect, the communication of the second audio data to the speech interface assistant is via an application programming interface (API) associated with the speech interface assistant. In some embodiments of this aspect, the processing circuitry is further configured to receive a response to an application programming interface (API) request, the API request indicating the second audio data; and determine whether the second audio data corresponds to the one of the responsive answer and the non-responsive answer based at least in part on the received response. In some embodiments of this aspect, the processing circuitry is further configured to, as a result of receiving a third audio data representing a user stop command, terminate an audio survey session and maintain a survey state for the user, the survey state at least indicating which of the plurality of survey questions have been answer and not answered by the user and the survey state being configured for use in a subsequent audio survey session with the user.

According to a second aspect of the present disclosure, a method for a computer for conducting a survey is provided. The method includes selecting a first audio data representing a first one of a plurality of survey questions to be output via a speaker, the speaker being associated with a user and a speech interface assistant; communicating the selected first audio data for output to the user via the speaker; receiving a second audio data as a result of the first one of the plurality of survey questions being output via the speaker; determining whether the second audio data corresponds to one of a responsive answer and a non-responsive answer to the first one of the plurality of survey questions; and performing one of a responsive process and a non-responsive process based at least in part on the determination of whether the second audio data corresponds to the one of the responsive answer and the non-responsive answer.

In some embodiments of this aspect, the responsive answer is a recognized answer and the non-responsive answer is an answer that is not recognized. In some embodiments of this aspect, the responsive process includes at least one of storing the second audio data in a survey database; and updating a persistent counter, the persistent counter being used to monitor which one of the plurality of survey questions was most recently communicated for output via the speaker. In some embodiments of this aspect, the non-responsive process includes at least one of repeating the first one of the plurality of survey questions; rephrasing the first one of the plurality of survey questions; and not updating the persistent counter. In some embodiments of this aspect, the determining whether the second audio data corresponds to the one of the responsive answer and the non-responsive answer further comprises determining whether the second audio data matches at least one predetermined answer corresponding to at least one intent. In some embodiments of this aspect, the determining whether the second audio data corresponds to the one of the responsive answer and the non-responsive answer further comprises communicating the second audio data to the speech interface assistant for verification by comparing the second audio data to a predetermined list, the predetermined list associated with the first one of the plurality of survey questions output via the speaker.

In some embodiments of this aspect, the method further includes receiving a response to an application programming interface (API) request, the API request indicating the second audio data; and determining whether the second audio data corresponds to the one of the responsive answer and the non-responsive answer based at least in part on the received response. In some embodiments of this aspect, the method further includes, as a result of receiving a third audio data representing a user stop command, terminating an audio survey session and maintaining a survey state for the user, the survey state at least indicating which of the plurality of survey questions have been answer and not answered by the user and the survey state being configured for use in a subsequent audio survey session with the user.

In yet a third aspect of the present disclosure, a system for conducting a survey is provided. The system includes a smart speaker associated with a user and a speech interface assistant, the smart speaker comprising a speaker and a microphone. The system includes at least one first computer in communication with the smart speaker, the at least one first computer configured to provide services associated with the speech interface assistant. The system includes at least one second computer in communication with the at least one first computer, the at least one second computer configured to provide at least one survey to the user via the smart speaker. The at least one second computer includes processing circuitry configured to select a first audio data representing a first one of a plurality of survey questions to be output via the smart speaker; communicate the selected first audio data for output to the user via the smart speaker; receive a second audio data as a result of the first one of the plurality of survey questions being output via the smart speaker; determine whether the second audio data corresponds to one of a responsive answer and a non-responsive answer to the first one of the plurality of survey questions; and perform one of a responsive process and a non-responsive process based at least in part on the determination of whether the second audio data corresponds to the one of the responsive answer and the non-responsive answer.

### BRIEF DESCRIPTION OF THE DRAWINGS

FIG. 1 is a block diagram of an exemplary system according to one embodiment of the present disclosure;

FIG. 2 is a flowchart illustrating an exemplary method implemented in a server according to one embodiment of the present disclosure;

FIG. 3 is a flowchart illustrating yet another exemplary method for conducting a survey according to one embodiment of the present disclosure;

FIG. 4 is a flowchart illustrating an example survey conducting process according to one embodiment of the present disclosure;

FIG. 5 illustrates an example of a smart speaker interaction in accordance with the principles of the present disclosure; and

FIG. 6 illustrates an example of a survey interaction pattern utilizing a smart speaker infrastructure according to one embodiment of the present disclosure.

### DETAILED DESCRIPTION

Some embodiments of this disclosure provide for improvements in the ability to conduct surveys, e.g., without the use or costs of interviewers and physical call centers. In some embodiments, respondents may not be required to physically log on to computers or mobile devices, which may increase survey response rates and/or reduce survey sample costs and time required to complete survey projects. Some embodiments of this disclosure provide for improvements for the survey respondents, e.g., in that respondents can take surveys on their own schedule and stop and start survey(s) at their leisure. This may provide a unique user experience different from a web browser, or phone-based survey. Some embodiments of this disclosure may allow for the combination of the positive attributes of telephone surveys (e.g., voice; conversational) with positive attributes of web browser-based surveys (e.g., speed, little or no labor costs, scalable at low cost, etc.) in a way that provides a pleasant user experience. Some embodiments of this disclosure can be used for executing, storing and analyzing the results any kind of inquirer-respondent dialogue, not just surveys. Some embodiments of this disclosure may also provide an alternative method of soliciting, gathering and organizing information and opinions from survey respondents.

Some embodiments of this disclosure provide software to conduct surveys using voice recognition platforms provided by “smart speaker systems”. Such software may e.g., recruit users, collect respondent demographics and be designed to conduct single surveys, or a series of surveys. In some embodiments, the system may include a host of back-end features to store and present collected data, as well. Also, a suite of front-end features may allow for a customizable user experience with guided surveys and context-aware assistance for users.

Some embodiments of the present disclosure relate to the use of a smart speaker platform (such as, for example, AMAZON'S ALEXA or other smart speaker platforms) to more efficiently conduct a survey. For example, the smart speaker platform may be programmed to conduct one or more surveys for a user, output survey questions (via the smart speaker's speaker), receive (via the smart speaker's microphone) the user's audible responses, and interpret the user's audible responses as human language words. In particular, some embodiments of the system or device may verify that the user's audible response is, in fact, a relevant response to the particular survey question and may map the user's audible response to a database of potential relevant answers. The system may also include the ability to keep track of the user's survey progress so that the user can return at any time and continue with the survey via the smart speaker, without requiring human intervention (e.g., a human interviewer on a telephone line).

In one aspect of this disclosure, the system or device may map survey questions and answers to search an intents algorithm to match the user's answers to expected answers to questions. As one simplistic example, the survey question may be a yes-no question and the intents/relevant answers for that question may be 1) yes, and 2) no. The two (2) intents/relevant answers may also be associated with potential human utterances/words (e.g., the yes-intent may be associated with the human utterances “yes,” “sure,” “absolutely,” “I agree,” and “yah;” and the no-intent may be associated with the human utterances “no,” “I don't think so,” I don't agree,” and “not really”). The system or device may then interpret the user's audible response and verify if such response matches one of the intents, i.e., yes or no intents. If the user's audible response does not match one of the expected intents/answers, the survey question may be repeated or the user asked to repeat his/her answer. Of note, techniques for speech to text and voice recognition are known and are beyond the scope of this invention.

As an example of a survey tracking mechanism, the system or device may include a persistent counter that keeps track of (e.g., increments) which question the user is currently on in the survey and another persistent counter that may keep track of which survey the user is currently engaging with as the user may take a progression of surveys and can pick up where he/she left off at any time with the smart speaker platform, according to the techniques provided in this disclosure.

Some embodiments of this disclosure provide for soliciting and conducting surveys, and gathering and organizing information and opinions from survey respondents, without conducting telephone surveys, paper surveys, or display-based online surveys. Thus, some embodiments of this disclosure may be an improvement in the ability to conduct surveys without the costs of interviewer staff housed in a physical call center and/or without the need for survey respondents to physically log on to computers to conduct the survey. Further, some embodiments of this disclosure may improve survey respondent experiences by allowing survey respondents to take surveys on-the-fly via a smart speaker platform and to start, stop and resume surveys at their own convenience.

Before describing in detail exemplary embodiments, it is noted that the embodiments reside primarily in combinations of apparatus components and processing steps related to conducting surveys. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, the terms “responsive” and “non-responsive” are used herein. The term “responsive” may be used to indicate audio data determined to be responsive to and/or relevant to a survey question. The term “non-responsive” may be used to indicate audio data determined to not be responsive to and/or not relevant to the survey question, as will be described in more detail below with examples.

In some embodiments, the term “utterance” is used herein and may be used to indicate a spoken word, statement, phrase or vocal sound, which may be detected by, for example, one or more microphones.

In some embodiments, the term “intent” is used herein and may indicate an expected, predetermined user answer to a question that is asked via a speaker. In some embodiments, a user's utterance may be mapped to an intent. In some embodiments, if a user's utterance cannot be mapped to an intent, the utterance may be determined as non-responsive.

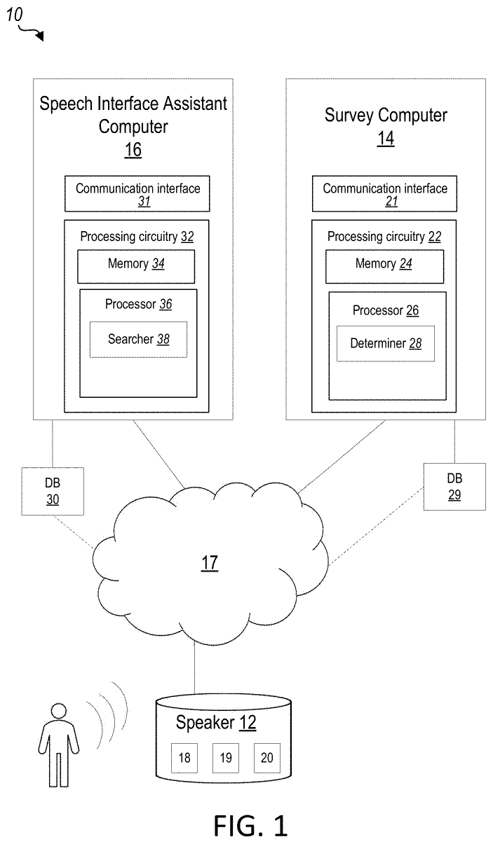

Referring now to the drawings, in which like reference designators refer to like elements, there is shown in FIG. 1, an exemplary system, and its related components, constructed in accordance with the principles of the present disclosure and designated generally as “10.” Referring to FIG. 1, system 10 may include a speaker 12, a survey computer 14 and a speech interface assistant computer 16, which may be in communication with one another over one or more networks 17 (e.g., the Internet, Cloud, wireless access network, etc.). The computers 14 and 16 may be any type of computer and/or computing device, such as, for example, a server computer, a personal computer (PC), a laptop, a tablet, etc. and/or may be distributed over the network 17 (e.g., distributed over one or more cloud computing devices in one or more cloud computing centers).

Before describing some of the hardware that may be included in these devices (speaker 12, a survey computer 14 and a speech interface assistant computer 16), a brief description of one example of such devices communicating with one another over the network 17 is provided. In one such example, a user may speak/utter a sound/audio signals (e.g., words, sentences, phrases, commands, questions, wake word (e.g., Alexa), etc.) within an environment proximate the speaker 12. A microphone 18 associated with the speaker 12 may receive the audio signal, which may be converted into a digital signal and processed by processing circuitry 19 associated with the speaker 12 to create audio data. The audio data may be communicated over the network 17, such as via a communication interface 21 associated with the speaker 12, to the speech interface assistant computer 16, which may be a server associated with the speech interface assistant (e.g., Alexa). In some embodiments, the speech interface assistant computer 16 may interpret the audio data and, based on the interpretation, may perform or initiate certain commands and/or may access yet another server, such as the survey computer 14, to provide a service, which may have been requested by the user via the utterance into the speaker 12. Thus, the speech interface assistant computer 16 may communicate a message to the survey computer 14, requesting such service, which may be the survey conducting services provided according to the techniques discussed in this disclosure. In other embodiments and with other smart speaker systems, the structure and communication between the speaker 12 and various support servers may be different than is described herein, but should generally facilitate providing various services via a speaker associated with a speech interface assistant. Audio data and other messages may be communicated between the speaker 12 and computers 14, 16 using any number of communication protocols, such as, for example, Transfer Control Protocol and Internet Protocol (TCP/IP) (e.g., any of the protocols used in each of the TCP/IP layers), Hypertext Transfer Protocol (HTTP), wireless application protocols, etc. In some embodiments, the computers 14 and 16 may be the same computer and therefore, the functionalities described herein with reference to one or the other of the computer 14 and 16 may, in some embodiments, be implemented in and/or by a single computer, or, in some alternative embodiments, more than two computers. Thus, although FIG. 1 shows computers 14 and 16 separately, in other embodiments, the functionalities described herein for the computers 14 and 16 may be in the same physical housing and/or using the same hardware components (e.g., same processing circuitry, memory, processors, communication interfaces, etc.).

Having generally described some example communications in the system 10, a more detailed description of some of the devices in the system 10 is provided below.

The speaker 12 may be a speaker associated with a speech interface assistant, such as, for example, a smart speaker (e.g., Amazon echo). The speaker 12 may include at least one microphone 18, processing circuitry 19 and a communication interface 20. The processing circuitry 19 may include one or more processors configured to process audio data for outputting as audio signals to a user via the speaker 12; process analog audio data received from the user via the microphone 18; and/or provide services associated with the speech interface assistant, according to the techniques described in this disclosure. In some embodiments, the communication interface 20 may include a network interface card configured to allow the speaker 12 to access the one or more wired and/or wireless network(s) 17 to communicate with other components in the network 17, such as the survey computer 14 and speech interface assistant computer 16. In some embodiments, the communication interface 20 may include a radio transceiver configured for wireless communications.

The survey computer 14 may be a server computer configured to provide services or skills to be utilized by the user via the speaker 12, such as, for example, the survey conducting techniques described in this disclosure. In some embodiments, the survey computer 14 may be located in the Cloud. In some embodiments, the survey computer 14 may be part of a backend system associated with one or more databases and/or processors configured to store, retrieve, process, analyze, generate and/or otherwise provide data to be provided via the speaker 12 and/or the speech interface assistant computer 16.

As shown in FIG. 1, in one embodiment, the survey computer 14 includes a communication interface 21, processing circuitry 22, and memory 24. The communication interface 21 may be configured to communicate with the speaker 12 and/or other elements in the system 10 to facilitate speaker 12 access to the services provided by the survey computer 14, such as the survey conducting techniques described in this disclosure. In some embodiments, the communication interface 21 may be formed as or may include, for example, one or more radio frequency (RF) transmitters, one or more RF receivers, and/or one or more RF transceivers, and/or may be considered a radio interface. In some embodiments, the communication interface 21 may also include a wired interface.

The processing circuitry 22 may include one or more processors 26 and memory, such as, the memory 24. In particular, in addition to a traditional processor and memory, the processing circuitry 22 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 26 may be configured to access (e.g., write to and/or read from) the memory 24, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the survey computer 14 may further include software stored internally in, for example, memory 24, or stored in external memory (e.g., database) accessible by the survey computer 14 via an external connection. The software may be executable by the processing circuitry 22. The processing circuitry 22 may be configured to control any of the methods and/or processes described herein and/or to cause such methods, and/or processes to be performed, e.g., by the survey computer 14. The memory 24 is configured to store data, programmatic software code and/or other information described herein. In some embodiments, the software may include instructions that, when executed by the processor 26 and/or the Determiner 28, causes the processor 26 and/or Determiner 28 to perform the processes described herein with respect to the survey computer 14. The Determiner 28 may be considered at least a portion of the processing circuitry 22 configured to perform one or more of the techniques described in this disclosure for the survey computer 14.

For example, the processing circuitry 22 and/or the Determiner 28 may be configured to (e.g., the memory 24 may store instructions executable by the processor 26 to configure the survey computer 14 to) select a first audio data representing a first one of a plurality of survey questions to be output via a speaker 12, the speaker 12 being associated with a user and a speech interface assistant. The processing circuitry 22 and/or the Determiner 28 may be configured to communicate, such as via communication interface 21, the selected first audio data for output to the user via the speaker 12. The processing circuitry 22 and/or the Determiner 28 may be configured to receive, such as via communication interface 21, a second audio data as a result of the first one of the plurality of survey questions being output via the speaker 12. The processing circuitry 22 and/or the Determiner 28 may be configured to determine whether the second audio data corresponds to one of a responsive answer and a non-responsive answer to the first one of the plurality of survey questions. The processing circuitry 22 and/or the Determiner 28 may be configured to perform one of a responsive process and a non-responsive process based at least in part on the determination of whether the second audio data corresponds to the one of the responsive answer and the non-responsive answer.

In some embodiments, the processing circuitry 22 and/or the Determiner 28 is further configured to determine whether the user utterance corresponds to the one of the responsive answer and the non-responsive answer by being configured to determine whether the user utterance matches at least one predetermined answer corresponding to at least one intent, the at least one intent being stored in an intents database (DB), such as for example DB 29 and/or DB 30. In some embodiments, DB 29 may be associated with the survey computer 14, while DB 30 is associated with the speech interface assistant computer 16. For example, in one implementation, DB 29 may be configured to store user information, survey and/or poll questions, user answers to questions, and/or all user surveys (e.g., for maintaining the persistent counter); while DB 30 is associated with the speech interface assistant back-end system (e.g., AMAZON, or other smart speaker platform). It should be understood that in other implementations, the information may be stored in other DBs, or a single DB, or be distributed in other ways. For example, although FIG. 1 shows the intents DB 29 and DB 30 as separate from the computers 14 and 16, in some embodiments, the intents DB 29 and DB 30 may be implemented in memory (e.g., memory 24) at one or both of computers 14 and 16 and/or may be implemented in the cloud via the network 17. Thus, the intents DB 29 and DB 30 are shown in the example architecture depicted in FIG. 1 as being in direct communication with the survey computer 14 and speech interface assistant computer 16, respectively; however, DB 29 and 30 may also be indirectly connected to the computers 14 and 16 via the network 17, or another network or connection.

In some embodiments, the responsive answer is a recognized answer and the non-responsive answer is an answer that is not recognized. In some embodiments, the responsive process includes at least one of storing the second audio data in a survey database; and updating a persistent counter, the persistent counter being used to monitor which one of the plurality of survey questions was most recently communicated for output via the speaker 12. In some embodiments, the non-responsive process includes at least one of repeating the first one of the plurality of survey questions; rephrasing the first one of the plurality of survey questions; and not updating the persistent counter.

In some embodiments, the processing circuitry 22 and/or the Determiner 28 is further configured monitor which one of the plurality of survey questions was most recently communicated for output via the speaker 12, the determination of whether the second audio data corresponds to the one of the responsive answer and the non-responsive answer based at least in part on the monitored one of the plurality of survey questions most recently output via the speaker 12. In some embodiments, the processing circuitry 22 and/or the Determiner 28 is further configured to determine whether the second audio data corresponds to the one of the responsive answer and the non-responsive answer by being configured to determine whether the second audio data matches at least one predetermined answer corresponding to at least one intent. In some embodiments, the processing circuitry 22 and/or the Determiner 28 is further configured to, as a result of the second audio data matching the at least one predetermined answer corresponding to the at least one intent, update a persistent counter and select a third audio data representing a second one of the plurality of survey questions to be output via the speaker 12 associated with the speech interface assistant; and, as a result of the second audio data not matching the at least one predetermined answer corresponding to the at least one intent, repeat the one of the plurality of survey questions most recently output. In some embodiments, the processing circuitry 22 and/or the Determiner 28 is further configured to determine whether the second audio data corresponds to the one of the responsive answer and the non-responsive answer by being configured to process the second audio data as a question by combining the second audio data with a most recently output one of the plurality of survey questions; and communicate, such as via communication interface 21, the processed question to the speech interface assistant for verification via an Internet search engine.

In some embodiments, the communication of the processed question to the speech interface assistant is via an application programming interface associated with the speech interface assistant. In some embodiments, the processing circuitry 22 and/or the Determiner 28 further configured to receive a response to the processed question; and determine whether the second audio data corresponds to the one of the responsive answer and the non-responsive answer based at least in part on the received response, the received response corresponding to a search engine result. In some embodiments, processing circuitry 22 and/or the Determiner 28 is further configured to, as a result of receiving a third audio data representing a user stop command, terminate an audio survey session and maintain a survey state for the user, the survey state at least indicating which of the plurality of survey questions have been answer and not answered by the user and the survey state being configured for use in a subsequent audio survey session with the user.

In some embodiments, the processing circuitry 22 and/or the Determiner 28 is further configured to determine whether the second audio data corresponds to the one of the responsive answer and the non-responsive answer by being configured to communicate the second audio data to the speech interface assistant for verification by comparing the second audio data to a predetermined list, in which the predetermined list is associated with the first one of the plurality of survey questions output via the speaker 12. In some embodiments, the communication of the second audio data to the speech interface assistant is via an application programming interface (API) associated with the speech interface assistant. In some embodiments, the processing circuitry 22 and/or the Determiner 28 is further configured to receive a response to an application programming interface (API) request and determine whether the second audio data corresponds to the one of the responsive answer and the non-responsive answer based at least in part on the received response. In some embodiments, the API request indicates the second audio data.

The speech interface assistant computer 16 may be a server computer configured to facilitate the provision of services to be utilized by the user via the speaker 12, such as, for example, the survey conducting techniques described in this disclosure. For example, the speech interface assistant computer 16 may be configured to provide one or more aspects of the speech interface assistant (e.g., speech-to-text translation, Internet search engine services, etc., which may be accessible by the survey computer 14 via e.g., APIs). In some embodiments, the speech interface assistant computer 16 may be located in the Cloud separate from the survey computer 14. In some embodiments, the speech interface assistant computer 16 may be part of a backend system associated with one or more databases and/or processors configured to store, retrieve, process, analyze, generate and/or otherwise provide data to be provided via the speaker 12 and/or the survey computer 14.

As shown in FIG. 1, in one embodiment, the speech interface assistant computer 16 includes a communication interface 31, processing circuitry 32, and memory 34. The communication interface 31 may be configured to communicate with the speaker 12 and/or other elements in the system 10 to facilitate speaker 12 access to the services provided by e.g., the survey computer 14, such as the survey conducting techniques described in this disclosure. In some embodiments, the communication interface 31 may be formed as or may include, for example, one or more radio frequency (RF) transmitters, one or more RF receivers, and/or one or more RF transceivers, and/or may be considered a radio interface. In some embodiments, the communication interface 31 may also include a wired interface.

The processing circuitry 32 may include one or more processors 26 and memory, such as, the memory 34. In particular, in addition to a traditional processor and memory, the processing circuitry 32 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 26 may be configured to access (e.g., write to and/or read from) the memory 34, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the speech interface assistant computer 16 may further include software stored internally in, for example, memory 34, or stored in external memory (e.g., database) accessible by the speech interface assistant computer 16 via an external connection. The software may be executable by the processing circuitry 32. The processing circuitry 32 may be configured to control any of the methods and/or processes described herein and/or to cause such methods, and/or processes to be performed, e.g., by the speech interface assistant computer 16. The memory 34 is configured to store data, programmatic software code and/or other information described herein. In some embodiments, the software may include instructions that, when executed by the processor 26 and/or the Searcher 38, causes the processor 26 and/or Searcher 38 to perform the processes described herein with respect to the speech interface assistant computer 16. The Searcher 38 may be considered at least a portion of the processing circuitry 32 configured to perform one or more of the techniques described in this disclosure for the speech interface assistant computer 16.

For example, the processing circuitry 32 and/or the Searcher 38 may be configured to (e.g., the memory 34 may store instructions executable by the processor 36 to configure the speech interface assistant computer 16 to) receive an indication of audio data (e.g., from the survey computer 14) for answer verification via e.g., a list matching API request; execute the API request; and/or return (e.g., to the survey computer 14) a response to the API request. For example, the response may indicate whether the audio data matches an item in a list, the list corresponding to a predetermined list of expected answers to the corresponding survey question or poll. For example, the question may ask what the user's favorite professional baseball team and thus the list may be a predetermined list of all professional baseball teams, where the API request may indicate whether the audio data matches at least one team in the list. In other embodiments, the processing circuitry and/or the Searcher 38 may perform other answer verification assistance processes for verifying whether the audio data is relevant or responsive to the question. In some embodiments, the processing circuitry 32 and/or the Searcher 38 may perform yet other operations associated with the speech interface assistant.

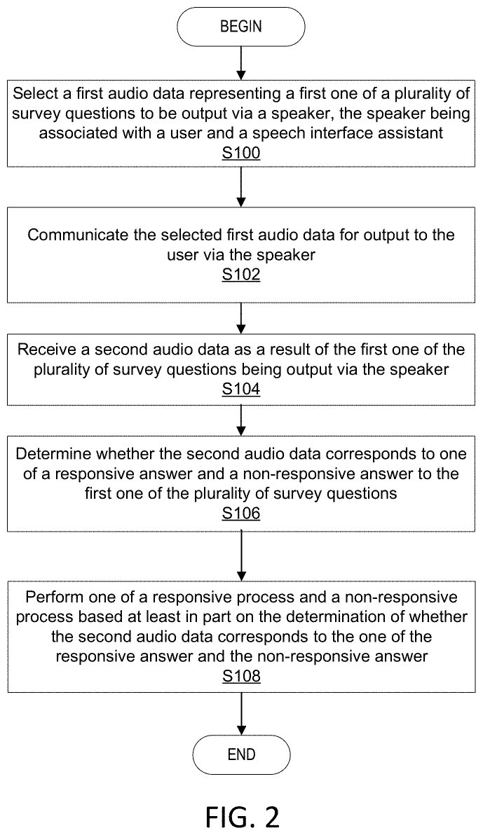

FIG. 2 is a flowchart illustrating an exemplary method that may be implemented in a device, such as, for example, the survey computer 14 for conducting surveys. The example method includes selecting (block S100), such as via processing circuitry 22 and/or the Determiner 28, a first audio data representing a first one of a plurality of survey questions to be output via a speaker, the speaker being associated with a user and a speech interface assistant. The method includes communicating (block S102), such as via communication interface 21, the selected first audio data for output to the user via the speaker 12. The method includes receiving (block S104), such as via processing circuitry 22 and/or the Determiner 28, a second audio data as a result of the first one of the plurality of survey questions being output via the speaker 12. The method includes determining (block S106), such as via processing circuitry 22 and/or the Determiner 28, determining whether the second audio data corresponds to one of a responsive answer and a non-responsive answer to the first one of the plurality of survey questions. The method includes performing (block S108), such as via processing circuitry 22 and/or the Determiner 28, one of a responsive process and a non-responsive process based at least in part on the determination of whether the second audio data corresponds to the one of the responsive answer and the non-responsive answer.

In some embodiments, the responsive answer is a recognized answer and the non-responsive answer is an answer that is not recognized. In some embodiments, the responsive process includes at least one of storing the second audio data in a survey database; and updating a persistent counter, the persistent counter being used to monitor which one of the plurality of survey questions was most recently communicated for output via the speaker 12. In some embodiments, the non-responsive process includes at least one of repeating the first one of the plurality of survey questions; rephrasing the first one of the plurality of survey questions; and not updating the persistent counter. In some embodiments, the determining whether the second audio data corresponds to the one of the responsive answer and the non-responsive answer further comprises determining, such as via processing circuitry 22 and/or the Determiner 28, whether the second audio data matches at least one predetermined answer corresponding to at least one intent.

In some embodiments, the determining whether the second audio data corresponds to the one of the responsive answer and the non-responsive answer further comprises processing, such as via processing circuitry 22 and/or the Determiner 28, the second audio data as a question by combining the second audio data with a most recently output one of the plurality of survey questions; and communicating, such as via communication interface 21, the processed question to the speech interface assistant for verification via an Internet search engine. In some embodiments, the method further includes receiving, such as via communication interface 21, a response to the processed question; and determining, such as via processing circuitry 22 and/or the Determiner 28, whether the second audio data corresponds to the one of the responsive answer and the non-responsive answer based at least in part on the received response, the received response corresponding to a search engine result. In some embodiments, the method further includes, as a result of receiving a third audio data representing a user stop command, terminating an audio survey session and maintaining a survey state for the user, the survey state at least indicating which of the plurality of survey questions have been answer and not answered by the user and the survey state being configured for use in a subsequent audio survey session with the user.

In some embodiments, the determining whether the second audio data corresponds to the one of the responsive answer and the non-responsive answer further includes communicating, such as via communication interface 21, the second audio data to the speech interface assistant for verification by comparing the second audio data to a predetermined list in which the predetermined list is associated with the first one of the plurality of survey questions output via the speaker. In some embodiments, the communicating, such as via communication interface 21, the second audio data to the speech interface assistant is via an application programming interface (API) associated with the speech interface assistant. In some embodiments, the method further includes receiving, such as via communication interface 21, a response to an application programming interface (API) request, the API request indicating the second audio data; and determining, such as via processing circuitry 22 and/or Determiner 28, whether the second audio data corresponds to the one of the responsive answer and the non-responsive answer based at least in part on the received response.

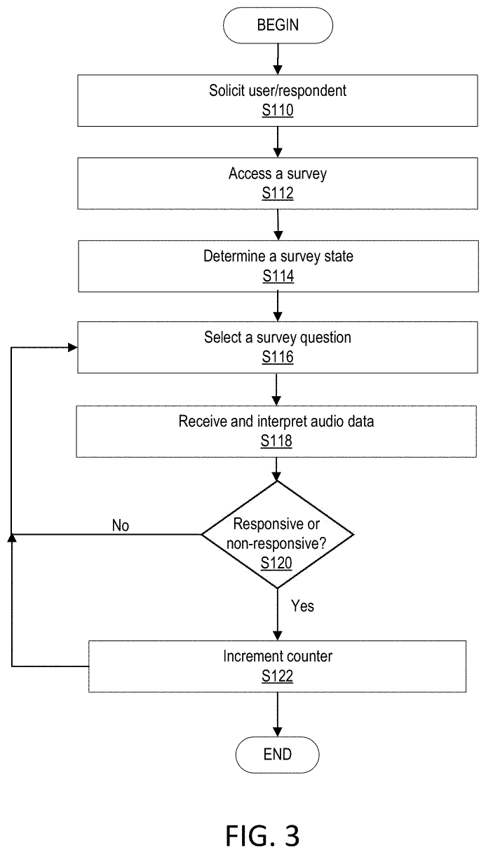

Having generally described some embodiments of the survey conducting techniques provided in this disclosure, a more detailed description of some of the embodiments is provided below, with reference to the flowchart of FIG. 3 as well as FIGS. 1, 4 and 5.

In block S110, the user may be solicited to participate in a survey conducted according to the techniques provided in this disclosure. For example, an electronic communication (e.g., email, text message, etc.) may be sent to the user requesting that the user participate in the survey. The user may be identified and targeted as a potential respondent according to any known technique for selecting survey respondents. In some embodiments, a unique participation code may be included in the electronic communication. The unique participation code (e.g., alphanumeric code) may be usable by the user to register with the system for participation in one or more surveys to be associated with the user's account and demographic information.

In some embodiments, the user may download an application and may take an onboarding survey, which involves registering the user in the system and inputting basic demographics (e.g., gender, age, etc.). The user may then be queued for a series of surveys that the user can take at any time via the speaker 12.

In block S112, the user may access a survey via the speaker 12. In some embodiments, the user may speak an utterance (e.g., command, wake word, etc.) in an environment proximate the speaker 12, which may be received via a microphone 18 on the speaker 12. For example, the utterance may include “Hello, Start Research Refined.” The user's utterance may be interpreted by the speaker 12 and/or speech interface assistant as instructing or prompting the speaker 12 and/or speech interface assistant to wake up and/or access the survey or survey application.

Advantageously, in some embodiments, the user can stop and start the survey at any time and the system 10 will maintain the user's place or survey state. In some embodiments, in block S114, a survey state for the user may be determined. For example, this may be achieved by creating user and survey objects that maintain persistence (e.g., outlives the process that created it such as by storing the state as data in computer data storage or non-transitory memory). The survey object may also control the linear nature of the survey interaction. In one embodiment, a persistent counter is maintained and incremented with each answered question, as the user progresses through each of the plurality of questions in the survey. This may allow e.g., the survey computer 14 to more accurately match responses/answers with questions, because the question that was previously asked is known and monitored by the computer 14 in some embodiments.

In block 116, the survey computer 14 may select a survey question e.g., based on the determined survey state. For example, if the user has not answered any survey questions, the survey computer 14 may select a first survey question to present to the user via the speaker 12; if the determined survey state indicates that the user has answered ten survey question in a survey of 20 questions, the survey computer 14 may select the eleventh survey question to present to the user via the speaker 12.

In block 118, after the appropriate survey question has been selected and output to the user via the speaker 12, audio data may be received and interpreted by e.g., the survey computer 14. The audio data may correspond to a user utterance spoken after and/or in response to the survey question. In some embodiments, the audio data may be digital audio data converted from analog audio signals (e.g., corresponding to the user's utterance) by the speaker 12 and/or the speech interface assistant computer 16 (e.g., speech-to-text). In some embodiments, natural language processing techniques may be used to interpret the audio data.

In block S120, a computer (e.g., the computer 16 and/or the computer 14) may determine whether the audio data is responsive, or non-responsive to the survey question, such as, the selected survey question from block S116. In some embodiments, the survey question may be associated with an intents database (e.g., database 30 and/or database 29) and the computer (e.g., the computer 16 and/or the computer 14) may determine whether the audio data matches an intent in the intents database. The intents database may store one or more predetermined responses that may correspond to an intent, which intent may be an expected response to the survey question. For example, the survey question may be “if given the choice, do you prefer historical documentaries or science shows” and the predetermined intents may include a first intent of “historical documentaries” (i.e., an expected answer/responsive answer) and a second intent of “science shows” (i.e., a second expected answer). In such example, if the user's utterance is “science shows” then the audio data may be considered to be responsive since the audio data matches one of the expected answers from the intents database. On the other hand, if the user's utterance is “neither” then the audio data may be considered non-responsive since the audio data does not match one of the expected answers.

In one embodiment, determining whether the audio data is responsive, or non-responsive to the survey question may be performed via an API request. For example, according to one implementation, computer 14 may send an API request indicating the user's audio data and/or a list (e.g., list of professional sports teams) associated with the question (e.g., “what is your favorite professional sports team?”). The computer 16 may compare the user's audio data with the indicated list to determine whether the audio data matches at least one item/team in the list. The computer 16 may send a response to computer 14 that indicates whether there is a match and computer 14 may determine whether the audio data corresponds to a responsive answer or a non-responsive answer based at least in part on the received response to the API request.

In an alternative embodiment, validation of whether the user's utterance is responsive or non-responsive may be performed by processing the user's utterance in the form of a question to be confirmed by e.g., the speech interface assistant, via an Internet search engine query. For example, if the user's utterance is “Baltimore Orioles,” the survey computer 14 may combine the user's utterance with the survey question to generate a processed question (e.g., Is the Baltimore Orioles a professional sports team?). This processed question may be then be used by the survey computer 14 to query an Internet search engine, e.g., associated with the speech interface assistant and/or speech interface assistant computer 16 to verify whether the utterance/audio data received is responsive or non-responsive to the survey question. For example, the speech interface assistant and/or the speech interface assistant computer 16 may receive the query (e.g., from the survey computer 14) corresponding to the processed/recombined question “Is the Baltimore Orioles a professional sports team?”. The speech interface assistant and/or the speech interface assistant computer 16 may perform the query and return a search result indicating that Baltimore Orioles is a professional baseball sports team. Thus, based on the search query result, the survey computer 14 may validate the user's utterance by determining that the audio data is responsive. On the other than, if the search query result(s) indicates that the user's utterance does not correspond to an expected answer, e.g., a professional sports team, the survey computer 14 may determine that the audio data is non-responsive.

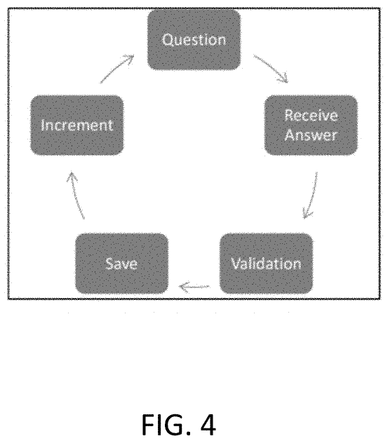

Accordingly, as can be seen in the example, response validation can be performed by using smart speaker services to implement an unconventional use of smart speakers to provide more efficient survey conducting techniques. Specifically, it is known that in a smart speaker system, the user typically asks a question of the smart speaker and the smart speaker responds with an answer. However, some embodiments of this disclosure provide for using the smart speaker 12 to ask a question to the user and to interpret the user's utterance as an answer to the question, and more specifically, interpreting whether the audio data is actually a responsive answer to the question or is non-responsive (e.g., background speech unrelated to the survey, answering an incorrect question, etc.). FIG. 4 is a flow diagram illustrating one example of a process flow for conducting a survey using the speaker 12 according to some embodiments of this disclosure. As shown in FIG. 4, the process flow proceeds in a circular and continuous manner until all the questions have been asked, as follows: 1) ask a question, 2) receive an answer, 3) validate the answer, 4) save the answer (e.g., if validated), and 5) increment the persistent counter.

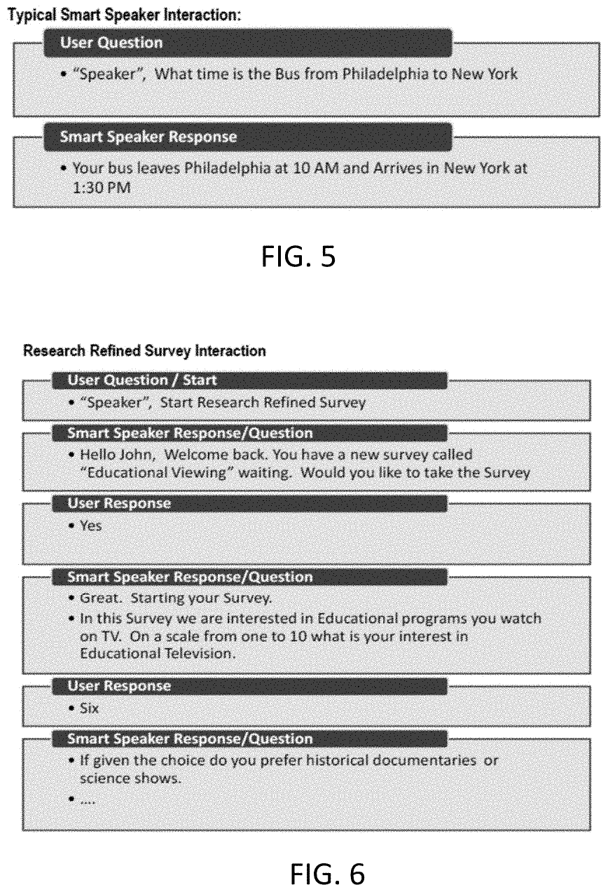

Use of the speaker 12 as described in this disclosure differs from typical smart speaker application or skills, which provide users with a more direct question-response model, as shown in FIG. 5. In contrast, some embodiments of this disclosure are capable of achieving a linear question-response pattern more in-line with question-response patterns a survey setting, as shown in FIG. 6, for example.

Returning again to the flowchart of FIG. 3, if the survey computer 14 determines that the response/answer does not match an expected response/answer, based on a predetermined expected response and/or another validation technique, the process can return to block S116, where the survey question is selected, which, in this case, may be to repeat the same survey question previously asked. In other embodiments, help options may also be provided for the user and/or the question may be rephrased, such as, by providing multiple potential answers that the user may choose from in, for example, a multiple choice selection.

On the other hand, if the user's utterance is determined by the survey computer 14 to be responsive in block S120, the process may proceed to block S122, where a persistent counter may be incremented in order to move the survey state to the next question in the survey (or to the next survey in a series of surveys). After the counter is updated, the process may proceed to block S116 where the next question is selected to be output to the user via the speaker 12. The process may be repeated and continued until the survey(s) are complete or until the user terminates the audio survey session or another termination event occurs. The user may terminate the session with an audio command, such as, for example, “stop survey” or any other termination command. Since the counter is persistent, the system may be able to determine where the user left off in the survey in a subsequent audio survey session, even after the current audio survey session is terminated.

Valid responses/responsive answers may be stored by e.g., survey computer 14 in, e.g., memory 24 and/or a survey results database. Accordingly, the responsive answers can be tabulated, organized, arranged and/or analyzed to produce useful information out of the survey results. For example, responsive answers related to consumer habits, such as favorite programs or sports teams, can be used to improve content offerings to particular consumers, e.g., consumers whose demographics overlap with demographics of survey respondents that indicated a preference for certain content offerings. Responsive answers may be analyzed and tabulated to provide other types of useful information, as well, in accordance with any known techniques for utilizing survey results.

Having described some example implementations of the techniques provided in this disclosure for data collection and survey conducting, some additional features are described below.

In some embodiments, one or more devices in the system will rely on existing or future Internet-based smart speaker APIs (e.g., AMAZON Ask and GOOGLE Actions APIs), and may map survey questions and answers to search “intents” algorithms to match expected answers to questions.

In some embodiments, one or more devices in the system provide an innovative solution that uses, but is not physically embodied within, user-owned computers and/or mobile devices to recruit and notify/communicate survey alerts to respondents.

In some embodiments, as an alternative to other 1) human and call center-based, 2) mail-based, 3) telephone, or 4) web browser-based surveys, elements of a smart speaker infrastructure may be used to create a more efficient survey structure. In some embodiments, software, executed by one or more processors described in this disclosure, may integrate voice services, speech recognition and natural language processing. In some embodiments, “intent,” “slot” and “utterances” applications may be used to streamline the process of identifying and validating responses to survey questions that are both likely and relevant/responsive.

In some embodiments, the techniques in this disclosure may be implemented using, for example, three modules, which may be stored at and/or implemented by, e.g., the survey computer 14 (such as via processing circuitry 22): 1) survey start, 2) survey respondent/user management, and 3) survey script creator. The first module may permit survey respondents to launch the survey application, as well as, commence and terminate specific survey events. The second module may manage survey respondents individually (e.g., individual demographics) and collectively (e.g., all respondents to a particular survey). The third module may formulate specific collection, storage and management of data and opinions provided by any number of survey respondents (R1 . . . Rn) to any number of surveys (S1 . . . Sn) comprised of any number of questions (Q1 . . . Qn), where “n” can be any number greater than 1.

In some embodiments, the process used in any particular implementation may depend on the simultaneous operation of all such modules to provide one or more of the following features:
Survey respondent may be invited to download a survey skill via a hyperlink in e.g., a text message or email message;
Survey respondent may open the link and key in an introduction code, complete standard demographics survey (e.g., module 1 and 2);
Survey respondent may be invited to a subsequent, subject/project-specific survey opportunity (e.g., module 3);
   specific content of subject/project-specific surveys may be prepared in advance of the survey in a survey script;
   survey script may integrate pre-built “intent,” “slot” and “utterances” and a natural language processing algorithm to e.g., apply a unique validation process to improve quality, reliability and projectability of survey responses (e.g., match survey response to relevant intents database); and
Individual survey respondents, individual surveys and individual survey questions and answers captured and maintained in e.g., module 2 to keep track of respondents' survey status (S1 . . . Sn, start/stop status, outstanding survey invitations, etc.) and retrieve project analysis.

In some embodiments, the techniques provided in this disclosure may provide organizations and users/respondents one of more of the following advantages and/or features:

utilizing voice-based technology to implement more natural/human processes for soliciting and providing data, personal opinions, etc. (as compared to traditional web-browser-based surveys requiring computer keyboarding responses);

utilizing digital invitation module, permitting targeted respondents to reply to inquires at a convenient time of their choosing (unlike face-to-face methods, or rare instances with telephone method follow-up/completion);

increased survey quality by incorporating relevant intents database into response validation processes; in effect, processing survey responses in the form of a question to be confirmed by a smart speaker;

increased survey quality by providing the respondent with a sense of personal anonymity/privacy when warranted depending upon the particular topic being surveyed;

utilizing voice-based technology and natural language processing, thereby eliminating many costs associated with telephone and mail survey methods, such as live telephone interviewer labor costs and mail survey costs (e.g., production, postage, etc.); and

increased likelihood, quality and usefulness of open-ended responses (full descriptive sentences rather than yes/no, likely/unlikely, 1 to 10 question-and-answer constraints, etc.).

Some additional embodiments of the present disclosure may include one or more of the following.

A method of conducting a survey, the method including:

outputting, via a speaker, a survey question of a plurality of predetermined survey questions;

receiving, via a microphone, an audio signal and recognizing at least a portion of the audio signal as a human utterance;

verifying that the human utterance is a relevant response to the outputted survey question of the plurality of survey questions by determining whether the human utterance matches at least one predetermined relevant answer corresponding to an intent at an intents database, the intent being associated with the survey question; and

providing a persistent counter of the plurality of predetermined survey questions where:

if the human utterance is verified as the relevant response, incrementing the persistent counter for a subsequent survey question of the plurality of predetermined survey questions and outputting, via the speaker, the subsequent survey question; and

if the human utterance is not verified as the relevant response, maintaining the persistent counter on the current survey question.

A method of conducting a questionnaire, the method including:

continuously listening, via a microphone of a speech user-interface device, for a first audio signal from a user;

in response to receiving the first audio signal, determining whether the first audio signal corresponds to a survey participant command to participate in an audio survey session conducted by a speech interface assistant, the audio survey session associated with at least one predetermined questionnaire including a plurality of predetermined survey questions to be outputted by the speech interface assistant during the audio survey session via a speaker of the speech user-interface device;

in response to a determination that the audio signal corresponds to the survey participant command to initiate the audio survey session, determine which one of the plurality of predetermined survey questions to output based on which of the plurality of predetermined survey questions were answered by the user during a previous audio survey session conducted by the speech interface assistant via the speech user-interface device;

outputting, by the speech interface assistant, via the speaker of the speech user-interface device, the determined one of the plurality of predetermined survey questions;

continuously listening, via the microphone of the speech user-interface device, for a second audio signal from the user; and

in response to receiving the second audio signal, recognizing the second audio signal as a human utterance and determining that the recognized human utterance is a relevant response to the outputted one of the plurality of predetermined survey questions by matching the human utterance to an intent, the intent corresponding to at least one predetermined relevant answer to the outputted survey question.

Accordingly, this disclosure provides novel techniques for soliciting and conducting surveys, and gathering and organizing information and opinions from survey respondents, without conducting telephone surveys, paper surveys, or display-based online surveys. Some embodiments of this disclosure may be an improvement in the ability to conduct surveys without the costs of interviewer staff housed in a physical call center and/or without the need for survey respondents to physically log on to computers to conduct the survey. Further, some embodiments of this disclosure may improve survey respondent experiences by allowing survey respondents to take surveys on-the-fly via a smart speaker platform and to start, stop and resume surveys at their own convenience. Some embodiments of this disclosure may advantageously increase response rates and data reliability, provide for more comprehensive responses from respondents and novel response validation techniques.

Although some embodiments of this disclosure may be described in terms of one or more known speech interface assistants or smart speaker systems, it should be understood that the techniques described in this disclosure may be beneficial for use with other types of smart speaker systems and the techniques of this disclosure are not intended to be limited to only the types discussed in this document, which are used merely as an example.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on a server device (e.g., survey computer 14), partly on the server device, as a stand-alone software package, partly on the server device and partly on another device (e.g., speech interface assistant computer 16 and/or speaker 12) or entirely on the other device. The user's speaker may be connected to the server device through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A computer for conducting a survey, the computer comprising processing circuitry configured to:
select a first audio data representing a first one of a plurality of survey questions to be output via a speaker, the speaker being associated with a user and a speech interface assistant;
communicate the selected first audio data for output to the user via the speaker;
receive a second audio data as a result of the first one of the plurality of survey questions being output via the speaker;
determine whether the second audio data corresponds to one of a responsive answer and a non-responsive answer to the first one of the plurality of survey questions; and
perform one of a responsive process and a non-responsive process based at least in part on the determination of whether the second audio data corresponds to the one of the responsive answer and the non-responsive answer.

2. The computer of claim 1, wherein the responsive answer is a recognized answer and the non-responsive answer is an answer that is not recognized.

3. The computer of claim 2, wherein the responsive process includes at least one of:
storing the second audio data in a survey database; and
updating a persistent counter, the persistent counter being used to monitor which one of the plurality of survey questions was most recently communicated for output via the speaker.

4. The computer of claim 3, wherein the non-responsive process includes at least one of:
repeating the first one of the plurality of survey questions;
rephrasing the first one of the plurality of survey questions; and
not updating the persistent counter.

5. The computer of claim 1, wherein the processing circuitry is further configured to monitor which one of the plurality of survey questions was most recently communicated for output via the speaker, the determination of whether the second audio data corresponds to the one of the responsive answer and the non-responsive answer based at least in part on the monitored one of the plurality of survey questions most recently output via the speaker.

6. The computer of claim 1, wherein the processing circuitry is further configured to determine whether the second audio data corresponds to the one of the responsive answer and the non-responsive answer by being configured to:
determine whether the second audio data matches at least one predetermined answer corresponding to at least one intent.

7. The computer of claim 6, wherein the processing circuitry is further configured to:
as a result of the second audio data matching the at least one predetermined answer corresponding to the at least one intent, update a persistent counter and select a third audio data representing a second one of the plurality of survey questions to be output via the speaker associated with the speech interface assistant; and
as a result of the second audio data not matching the at least one predetermined answer corresponding to the at least one intent, repeat the one of the plurality of survey questions most recently output.

8. The computer of claim 1, wherein the processing circuitry is further configured to determine whether the second audio data corresponds to the one of the responsive answer and the non-responsive answer by being configured to:
communicate the second audio data to the speech interface assistant for verification by comparing the second audio data to a predetermined list, the predetermined list associated with the first one of the plurality of survey questions output via the speaker.

9. The computer of claim 8, wherein the communication of the second audio data to the speech interface assistant is via an application programming interface (API) associated with the speech interface assistant.

10. The computer of claim 1, wherein the processing circuitry is further configured to:
receive a response to an application programming interface (API) request, the API request indicating the second audio data; and
determine whether the second audio data corresponds to the one of the responsive answer and the non-responsive answer based at least in part on the received response.

11. The computer of claim 1, wherein the processing circuitry is further configured to:
as a result of receiving a third audio data representing a user stop command, terminate an audio survey session and maintain a survey state for the user, the survey state at least indicating which of the plurality of survey questions have been answer and not answered by the user and the survey state being configured for use in a subsequent audio survey session with the user.

12. A method for a computer for conducting a survey, the method comprising:
selecting a first audio data representing a first one of a plurality of survey questions to be output via a speaker, the speaker being associated with a user and a speech interface assistant;
communicating the selected first audio data for output to the user via the speaker;
receiving a second audio data as a result of the first one of the plurality of survey questions being output via the speaker;
determining whether the second audio data corresponds to one of a responsive answer and a non-responsive answer to the first one of the plurality of survey questions; and
performing one of a responsive process and a non-responsive process based at least in part on the determination of whether the second audio data corresponds to the one of the responsive answer and the non-responsive answer.

13. The method of claim 12, wherein the responsive answer is a recognized answer and the non-responsive answer is an answer that is not recognized.

14. The method of claim 13, wherein the responsive process includes at least one of:
storing the second audio data in a survey database; and
updating a persistent counter, the persistent counter being used to monitor which one of the plurality of survey questions was most recently communicated for output via the speaker.

15. The method of claim 14, wherein the non-responsive process includes at least one of:
repeating the first one of the plurality of survey questions;
rephrasing the first one of the plurality of survey questions; and
not updating the persistent counter.

16. The method of claim 13, wherein the determining whether the second audio data corresponds to the one of the responsive answer and the non-responsive answer further comprises:
determining whether the second audio data matches at least one predetermined answer corresponding to at least one intent.

17. The method of claim 12, wherein the determining whether the second audio data corresponds to the one of the responsive answer and the non-responsive answer further comprises:
communicating the second audio data to the speech interface assistant for verification by comparing the second audio data to a predetermined list, the predetermined list associated with the first one of the plurality of survey questions output via the speaker.

18. The method of claim 17, further comprising:
receiving a response to an application programming interface (API) request, the API request indicating the second audio data; and
determining whether the second audio data corresponds to the one of the responsive answer and the non-responsive answer based at least in part on the received response.

19. The method of claim 12, further comprising:
as a result of receiving a third audio data representing a user stop command, terminating an audio survey session and maintaining a survey state for the user, the survey state at least indicating which of the plurality of survey questions have been answer and not answered by the user and the survey state being configured for use in a subsequent audio survey session with the user.

20. A system for conducting a survey, the system comprising:
a smart speaker associated with a user and a speech interface assistant, the smart speaker comprising a speaker and a microphone;
at least one first computer in communication with the smart speaker, the at least one first computer configured to provide services associated with the speech interface assistant; and
at least one second computer in communication with the at least one first computer, the at least one second computer configured to provide at least one survey to the user via the smart speaker and the at least one second computer comprising processing circuitry configured to:
select a first audio data representing a first one of a plurality of survey questions to be output via the smart speaker;
communicate the selected first audio data for output to the user via the smart speaker;
receive a second audio data as a result of the first one of the plurality of survey questions being output via the smart speaker;
determine whether the second audio data corresponds to one of a responsive answer and a non-responsive answer to the first one of the plurality of survey questions; and
perform one of a responsive process and a non-responsive process based at least in part on the determination of whether the second audio data corresponds to the one of the responsive answer and the non-responsive answer.
